(19) United States
(12) Patent Application Publication
(10) Pub. No.: US 2022/0027750 A1
(43) Pub. Date: Jan. 27, 2022

(54) REAL-TIME MODIFICATION OF RISK MODELS BASED ON FEATURE STABILITY

(71) Applicant: PAYPAL, INC., San Jose, CA (US)

(72) Inventors: Charles Poli, London (GB); Tarun Giri, San Jose, CA (US)

(21) Appl. No.: 16/935,953

(22) Filed: Jul. 22, 2020

(51) Int. Cl. G06N 5/04; G06N 20/00; G06Q 20/40; G06F 16/23

(52) U.S. Cl. CPC G06N 5/04; G06N 20/00; G06F 16/2365; G06F 16/2379; G06Q 20/4016

(57) ABSTRACT

Methods and systems are presented for dynamically modifying a risk model based on detected shifts of input features. Input values corresponding to an input feature and associated with transactions may be obtained. A distribution of the input values is determined, and compared against a benchmark distribution. An anomaly is detected when a difference between the distribution of the input values and the benchmark distribution exceeds a threshold. Based on the detected anomaly, a risk model configured to perform risk predictions for incoming transaction requests may be modified. Input values corresponding to the input feature may be monitored to determine if the anomaly is sustained or receded. The modified risk model may be reverted back to the original risk model when the anomaly no longer exists.

### BACKGROUND

The present specification generally relates to risk and fraud modeling, and more specifically, to dynamically modifying a computer-based risk model based on the stability of input features according to various embodiments of the disclosure.

### RELATED ART

Machine learning techniques are useful tools for identifying real-world behavior. A machine learning model can be trained to learn patterns of real-world behavior and may use the learned pattern to perform predictions (e.g., risk predictions, etc.). For example, an online service provider that receives transaction requests (e.g., login requests, content access requests, payment requests, purchase requests, etc.) may train one or more machine learning models to recognize behavior patterns of legitimate transaction attempts and behavior patterns of fraudulent transaction attempts. The trained machine learning models may then be used to predict a risk associated with a transaction request (or classify the transaction request as a level of a risk classification such as low, medium, or high risk) based on the recognized behavior patterns. Thus, when the transaction request is composed of (or matches) one or more learned patterns that are associated with fraudulent transactions, the machine learning model may classify the transaction request as high risk.

However, certain real-world events may cause the behavior of legitimate transactions to abruptly shift. For example, a seasonal sports event may cause the monetary amounts of ticket sales with a particular vendor to rise dramatically for a period of time. The sudden shift of behavior may cause the machine learning model to incorrectly classify legitimate transactions as fraudulent transactions and vice versa. Also, subsequent decisions made based on the machine learning model might affect the business operations. Since training the machine learning model to recognize new patterns can take a substantial amount of time, data, and processing (e.g., collecting and correctly labeling training data, etc.), the machine learning model may not be updated in time to recognize the new behavior, which may result in incorrect or inaccurate predictions. Thus, there is a need for providing a mechanism to dynamically alert and modify a machine learning model to recognize sudden shifts of behavior.

### BRIEF DESCRIPTION OF THE FIGURES

FIG. 1 is a block diagram illustrating an electronic transaction system according to an embodiment of the present disclosure;

FIG. 2 is a block diagram illustrating a risk determination module according to an embodiment of the present disclosure;

FIG. 3 illustrates distributions of input values according to an embodiment of the present disclosure;

FIG. 4 is a flowchart showing a process of dynamically modifying a risk model according to an embodiment of the present disclosure; and

FIG. 5 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for dynamically modifying a computer-based risk model based on detected shifts of one or more features (e.g., one or more input variables). As discussed above, an online service provider may generate a risk model for performing risk predictions on incoming transaction requests. In some embodiments, the risk model may be a rule-based (e.g., branches of a decision tree). A human operator may analyze data associated with past transactions to derive behavior patterns, such as patterns associated with a legitimate transactions and patterns associated with fraudulent transactions. The human operator may then configure the risk model by determining rules and parameters in the risk model.

In some embodiments, the risk model may be a machine learning model that can be trained with historic training data associated with past transactions conducted with the online service provider. By training the machine learning model with the historic data, the machine learning model may learn behavior patterns associated with legitimate transactions and behavior patterns associated with fraudulent transactions.

The risk model that has been configured and/or trained may then be used by the online service provider for predicting risk associated with incoming transaction requests by matching behavior (e.g., data values, features, etc.) associated with the incoming transaction requests with one or more of the learned behavior patterns. As discussed above, the behavior patterns associated with legitimate transactions may change over time, or for a period of time, for example, due to external factors such as one or more real-world events. In one example, a seasonal event (e.g., the World Cup that occurs every four years) may cause the monetary amounts of ticket sales with a particular vendor to rise dramatically (e.g., relative to the norm based on the training data) for a period of time (e.g., during the few months leading up to the event). The sudden shift of behavior may cause the risk model to incorrectly classify legitimate transactions as fraudulent transactions based on the deviation of the behavior from the norm. Conventionally, the online service provider may use data associated with the recent transactions to re-configure the risk model. For example, the human operator may analyze data periodically and update the rule-based model (e.g., updating the rules in the mode). However, it takes a substantial amount of human resources to continuously monitor and update the rule-based model. In the case where the risk model is a machine learning model, the online service provider may also use the data to re-train the machine learning model. However, it takes a substantial amount of time to obtain sufficient amounts of training data (e.g., it can take several months to accurately label each transaction request being legitimate or fraudulent for use as training data) for re-training the machine learning model. By the time the machine model is re-trained, many transactions have already been mis-classified. Worse yet, the behavior pattern of legitimate transactions may have shifted back to normal (e.g., World Cup season is over), which may result in additional misclassifications by the re-trained machine learning model.

Thus, according to various embodiments of the disclosure, a risk determination system may dynamically adjust a risk model based on detected shifts of input features. When an incoming transaction request is received by the risk determination system, the risk determination system may determine multiple values corresponding to input features that are used by the risk model for risk prediction based on the transaction request. The input features may include attributes of the transaction request, such as an amount, a currency used, an identifier of the merchant, a location of the transaction, a category of the product and/or service being purchased, etc. The input features may include attributes associated with a user account through which the transaction request is conducted, such as an identity of the user account, a transaction history of the user account, an address associated with the user account, etc. The input features may also include attributes associated with the device used to conduct the transaction request, such as an Internet Protocol (IP) address associated with the device, a geographical location of the device, a browser used by the device to conduct the transaction request, etc.

In some embodiments, the risk determination system may analyze values corresponding to the input features associated with multiple transactions that have processed by the risk model over a period of time (e.g., a past day, a past week, etc.). For example, the risk determination system may determine distribution statistics of the values corresponding to a particular feature. Using the amount input feature as an example, the distribution statistics may include a minimum amount, a maximum amount, a standard deviation, a skewness value, a kurtosis value, a cardinality value (e.g., a number of different amounts). Using the address input feature as another example, the distribution statistics may include a standard deviation, a skewness value, a kurtosis value, a cardinality value (e.g., a number of different regions, such as cities, states, countries, etc.), and a percentage of null values in one of the address fields.

The risk determination system may compare the distribution statistics against benchmark statistics (e.g., the norm). In some embodiments, the benchmark statistics may be determined based on values corresponding to the particular input feature associated with transactions processed by the risk model over another period of time (e.g., an earlier period of time such as the past month or the past year). If the distribution statistics of the recent transactions match the benchmark statistics (e.g., having a deviation below a threshold), the risk determination system may determine to not modify the risk model, and may continue to use the risk model to perform risk predictions for subsequent incoming transaction requests.

However, if the distribution statistics of the recent transactions deviate from the benchmark statistics by more than the threshold, the risk determination system may determine that a shift in transaction behavior (e.g., legitimate transaction behavior) has likely occurred. The risk determination system may then modify the risk model to accommodate the shift in transaction behavior. For example, the risk determination system may adjust one or more parameters within the risk model in determining a risk of a transaction request (or classify the transaction request as legitimate or fraudulent). In some embodiments, the risk model may be configured and/or trained to recognize that a transaction from a particular vendor having a transaction amount over a threshold amount is considered high risk based on training data that indicates that a large portion of past transactions with this particular vendor are associated with amounts below the threshold. When the risk determination system detects the shift of behavior pattern where a large portion of recent transactions (e.g., transaction conducted from the day) has transaction amounts over the threshold amount, the risk determination system may normalize and counter the detected shifts to fit into the earlier distribution. For example, the risk determination system may modify the risk model by adjusting the amount threshold parameter (e.g., by increasing the amount threshold parameter).

In some embodiments, the risk determination system may also transmit an alert to a device associated with the online service provider such that a person associated with the online service provider may perform additional investigation regarding the shift of behavior pattern. In some embodiments, the risk determination system may perform additional investigation when the shift of behavior pattern is detected. For example, the risk determination system may include a web crawler to obtain news from various websites on the Internet. The risk determination system may analyze news report to determine whether a correlation exists between a news report and the pattern shift. In some embodiments, the risk determination system may perform linguistic analysis on the news report to detect whether words and phrases within the news report correlate to the particular input feature. Using the above example where an increase in transaction amounts in transactions with the particular vendor has occurred, the risk determination system may determine whether any news report includes words or phrases related to the name of the particular vendor, a category of the particular vendor, and/or products associated with the particular vendor (e.g., sports event tickets, etc.). In some embodiments, the risk determination system may modify the risk model to accommodate the shift in transaction pattern only after the shift in transaction pattern has been verified (e.g., determining a correlation between the shift in transaction pattern and a news report, etc.).

Since the sudden shift in transaction behavior may be a temporary shift (e.g., until the end of the sports event), it may not be desirable to use the modified risk model permanently. Thus, in some embodiments, the risk determination system may determine an expiration time to the modification to the risk model. The risk determination system of some embodiments may assign an initial expiration time (e.g., a first expiration time, such as a day, 2 days) for the modification to the risk model, such as based on an expected time the modified behavior may end, e.g., the day after the World Cup ends in the above example. At the expiration time, the risk determination system may revert the modified risk model back to the original risk model before the modification (e.g., reverting the adjusted parameters back to the original parameters prior to the modification).

After modifying the risk model, the risk determination system may continue to monitor values associated with incoming transaction requests that correspond to the particular feature. For example, the risk determination system may obtain values corresponding to the particular feature and associated with transaction requests after the risk model is modified (e.g., for transaction requests submitted in the past 6 hours, 12 hours, 24 hours, etc.). The risk determination system may also determine distribution statistics based on the values associated with the incoming transaction requests. The risk determination system may compare the distribution statistics against the benchmark statistics (e.g., the norm) and/or the previously determined distribution statistics. In some embodiments, based on the comparison and the amount of time elapsed since the shift of the transaction pattern, the risk determination system may adjust the expiration time associated with the modification to the risk model. For example, if the comparison shows that the shift of the transaction behavior remains, the risk determination system may extend the expiration time for the modification to the risk model. In some embodiments, the risk determination system may extend the expiration time based on the amount of time elapsed since the shift of the transaction pattern. The longer the transaction pattern has been shifted, the longer the risk determination system may extend the expiration time. For example, the risk determination system may extend the expiration time by the amount of time elapsed since the shift of the transaction pattern. Thus, if the shift of the transaction pattern has lasted for a day, the risk determination system may extend the expiration time by a day. In some embodiments, when it is determined that the shift of transaction pattern has lasted longer than a threshold period of time (e.g., several months, etc.), the risk determination system may remove the expiration time such that the modification to the risk model is permanent.

In some embodiments, if the comparison shows that the shift of the transaction behavior has receded (e.g., the deviation from the benchmark statistics is smaller than the previous deviation) and/or has ended (e.g., the deviation is less than the threshold), the risk determination system may reduce the expiration time. For example, the risk determination system may reduce (or shorten) the expiration time of the modification to the risk model based on a difference between the deviation associated with the current distribution statistics and the previous deviation associated with the previous distribution statistics. Thus, the risk determination system may reduce (or shorten) the expiration time by a greater extent when the difference is greater and by a smaller extent when the difference is smaller.

In some embodiments, the risk determination system may continue to monitor the values corresponding to the particular feature and other features associated with incoming transaction requests to determine whether the shift of the transaction pattern continues and whether a different shift of the transaction pattern is detected. The risk determination system may continue to modify the risk model using the techniques described herein based on the shift of the transaction pattern detected using values of input features. By modifying the risk model based on detected shifts of input values (instead of changes in the labeling of transaction requests), the risk model can be dynamically modified to accommodate the shift of transaction behavior pattern, which can substantially improve accuracy of fraudulent transaction request prediction and network security.

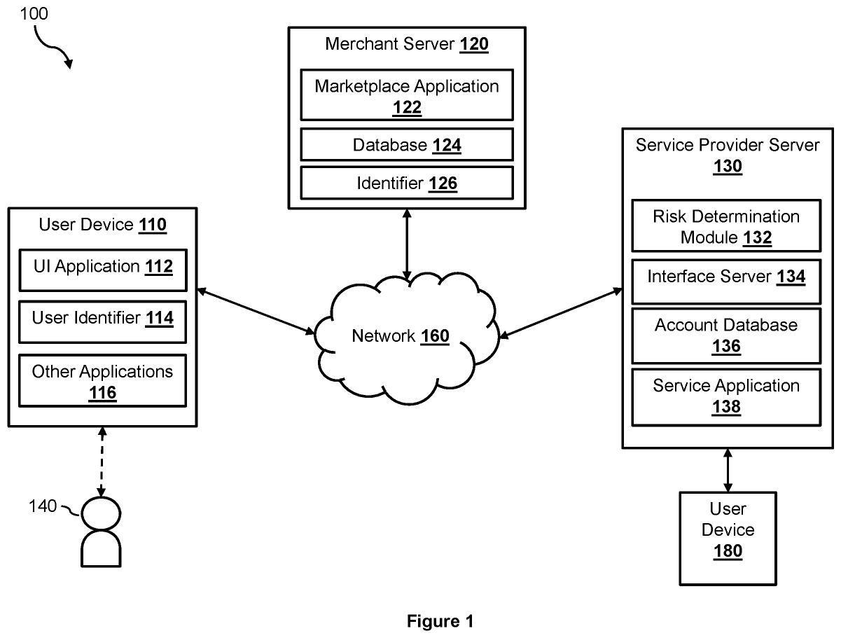

FIG. 1 illustrates an electronic transaction system 100, within which the risk determination system described herein may be implemented according to one embodiment of the disclosure. The electronic transaction system 100 includes a service provider server 130, a merchant server 120, and a user device 110 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120 and/or the service provider server 130 over the network 160. For example, the user 140 may use the user device 110 to conduct an online purchase transaction with the merchant server 120 via a website hosted by the merchant server 120, a mobile application associated with the merchant server 120, or a point-of-sale (POS) system associated with the merchant server 120. The user 140 may also log in to a user account to access account services or conduct electronic transactions (e.g., account transfers or payments) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to conduct electronic transactions (e.g., online payment transactions, etc.) with the merchant server 120 and/or the service provider server 130 over the network 160. In one aspect, purchase expenses may be directly and/or automatically debited from an account related to the user 140 via the user interface application 112.

In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160.

The user device 110, in various embodiments, may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 for improved efficiency and convenience.

The user device 110, in one embodiment, may include at least one user identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile) maintained by the service provider server 130.

In various implementations, the user 140 is able to input data and information into an input component (e.g., a keyboard) of the user device 110 to provide user information with a transaction request, such as a login request, a fund transfer request, a request for adding an additional funding source (e.g., a new credit card), or other types of request. The user information may include user identification information.

Even though only one user device 110 is shown in FIG. 1, it has been contemplated that one or more user devices (each similar to user device 110) may be communicatively coupled with the service provider server 130 via the network 160 within the system 100.

The merchant server 120, in various embodiments, may be maintained by a business entity (or in some cases, by a partner of a business entity that processes transactions on behalf of business entity). Examples of business entities include merchant sites, resource information sites, utility sites, real estate management sites, social networking sites, etc., which offer various items for purchase and process payments for the purchases, as well as provide content and account services to users. The merchant server 120 may include a merchant database 124 for identifying available items, which may be made available to the user device 110 for viewing and purchase by the user.

The merchant server 120, in one embodiment, may include a marketplace application 122, which may be configured to provide information over the network 160 to the user interface application 112 of the user device 110. For example, the user 140 of the user device 110 may interact with the marketplace application 122 through the user interface application 112 over the network 160 to search and view various items available for purchase in the merchant database 124. The merchant server 120, in one embodiment, may include at least one merchant identifier 126, which may be included as part of the one or more items made available for purchase so that, e.g., particular items are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

A merchant may also use the merchant server 120 to communicate with the service provider server 130 over the network 160. For example, the merchant may use the merchant server 120 to communicate with the service provider server 130 in the course of various services offered by the service provider to a merchant, such as payment intermediary between customers of the merchant and the merchant itself. For example, the merchant server 120 may use an application programming interface (API) that allows it to offer sale of goods or services in which customers are allowed to make payment through the service provider server 130, while the user 140 may have an account with the service provider server 130 that allows the user 140 to use the service provider server 130 for making payments to merchants that allow use of authentication, authorization, and payment services of the service provider as a payment intermediary. Even though only one merchant server 120 is shown in FIG. 1, it has been contemplated that one or more merchant servers (each similar to merchant server 120) may be communicatively coupled with the service provider server 130 and the user device 110 via the network 160 in the system 100. As such, the service provider server 130 may facilitate payment transactions for users with different merchants associated with different merchant servers similar to the merchant server 120.

The service provider server 130, in one embodiment, may be maintained by a transaction processing entity or an online service provider, which may provide processing for electronic transactions between users (e.g., the user 140 of user device 110), between merchants, and/or between users and merchants. As such, the service provider server 130 may include a service application 138, which may be adapted to interact with the user device 110 and/or the merchant server 120 over the network 160 to facilitate the searching, selection, purchase, payment of items, and/or other services offered by the service provider server 130. In one example, the service provider server 130 may be provided by PayPal®, Inc., of San Jose, Calif., USA, and/or one or more service entities or a respective intermediary that may provide multiple point of sale devices at various locations to facilitate transaction routings between merchants and, for example, service entities.

In some embodiments, the service application 138 may include a payment processing application (not shown) for processing purchases and/or payments for electronic transactions between a user and a merchant or between any two entities. In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various service provided by the service provider server 130. The interface server 134 may also include other electronic pages associated with the different services (e.g., electronic transaction services, etc.) offered by the service provider server 130. As a result, a user may access a user account associated with the user and access various services (e.g., initiating and conducting electronic transactions, etc.) offered by the service provider server 130, by generating HTTP requests directed at the service provider server 130.

The service provider server 130, in one embodiment, may be configured to maintain one or more user accounts and merchant accounts in an account database 136, each of which may be associated with a profile and may include account information associated with one or more individual users (e.g., the user 140 associated with user device 110) and merchants. For example, account information may include private financial information of users and merchants, such as one or more account numbers, passwords, credit card information, banking information, digital wallets used, or other types of financial information, transaction history (e.g., transaction records, transaction request records, etc.), Internet Protocol (IP) addresses, device information associated with the user account. In certain embodiments, account information also includes user purchase profile information such as account funding options and payment options associated with the user, payment information, receipts, and other information collected in response to completed funding and/or payment transactions.

In one implementation, a user may have identity attributes stored with the service provider server 130, and the user may have credentials to authenticate or verify identity with the service provider server 130. User attributes may include personal information, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 includes a risk determination module 132 that implements the risk determination system as discussed herein. In some embodiments, the risk determination module 132 may generate a risk model for performing risk predictions for transaction requests received by the service provider server 130 from devices such as the user device 110 and/or the merchant server 120. The risk determination module 132 may be configured to dynamically modify the risk model based on stability of input features associated with incoming transaction requests. In some embodiments, the risk determination module 132 may determine benchmark statistics for each of the input features based on past transactions conducted through the online service provider, such as during a similar time period or event, e.g., during a previous World Cup using the example above. The risk determination module 132 may then obtain values corresponding to a particular input feature from transaction requests received during a first period time (e.g., the last 24 hours). The risk determination module 132 may determine distribution statistics based on the values and compare the distribution statistics against the benchmark statistics.

If it is determined that the distribution statistics deviates from the benchmark statistics more than a threshold, the risk determination module 132 may modify the risk model by adjusting one or more parameters in the risk model. In some embodiments, the risk determination module 132 may also send an alert to the user device 180 indicating the sudden shift of transaction behavior. The user device 180 may have similar components as the user device 110 and may be associated with a person working for the online service provider.

The risk determination module 132 may determine an initial expiration time associated with the modification of the risk model, such that after the expiration time has passed, the risk determination module 132 may revert the modified risk model back to the original risk model. The risk determination module 132 may continue to monitor the values corresponding to the particular input feature based on incoming transaction request and may determine to either extend the expiration time, shorten the expiration time, or make the modification to the risk model permanent. The risk determination module 132 may use the modified risk model to process incoming transaction requests.

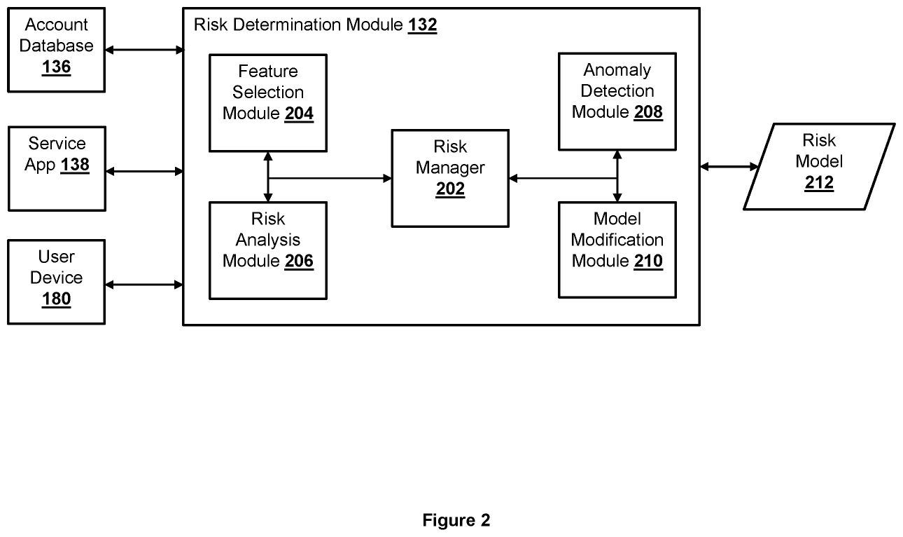

FIG. 2 illustrates a block diagram of the risk determination module 132 according to an embodiment of the disclosure. The risk determination module 132 includes a risk manager 202, a feature selection module 204, a risk analysis model 206, an anomaly detection module 208, and a model modification module 210. Some or all of the risk manager 202, the feature selection module 204, the risk analysis model 206, the anomaly detection module 208, and the model modification module 210 may be implemented as computer software programs or as hardware storing and running computer software programs.

In some embodiments, the risk manager 202 may generate a risk model 212 for performing risk predictions on incoming transaction requests. In some embodiments, the risk manager 202 may generate the risk model 212 as a rule-based model, such as a decision tree. A human operator may analyze data associated with past transactions to derive behavior patterns, such as patterns associated with a legitimate transactions and patterns associated with fraudulent transactions. The human operator may then use the derived patterns to generate rules for the rule-based model. An example rule may include increasing a risk score by a value if the transaction request is associated with a particular merchant and the amount exceeds a particular threshold amount.

In some embodiments, the risk model 212 may be a machine learning model that can be trained with training data (e.g., historic data) associated with past transactions conducted with the service provider server 130. By training the machine learning model with the training data (e.g., the historic data), the machine learning model may learn behavior patterns associated with legitimate transactions and behavior patterns associated with fraudulent transactions. For example, one or more nodes (e.g., in the hidden layer) of the machine learning model may include different parameters, which may affect how input values of the machine learning model will affect an output of the machine learning model. Thus, when a majority of past transactions with the particular merchant are associated with amounts below a particular amount, the machine learning model may automatically assign a parameter (e.g., the particular amount threshold) to one or more of the nodes in the hidden layer such that a risk output value may increase when an incoming transaction request associated with the particular merchant has an amount that exceeds the particular amount threshold.

In some embodiments, the risk model 212 may be configured to produce an output value (e.g., a risk value, a risk score) for a transaction request based on values associated with the transaction request that correspond to a set of input features. The input features may include attributes of the transaction request, such as an amount, a currency used, an identifier of the merchant, a location of the transaction, a category of the product and/or service being purchased, etc. The input features may include attributes associated with a user account through which the transaction request is conducted, such as an identity of the user account, a transaction history of the user account, an address associated with the user account, etc. The input features may also include attributes associated with the device used to conduct the transaction request, such as an Internet Protocol (IP) address associated with the device, a geographical location of the device, a browser used by the device to conduct the transaction request, etc.

The risk model 212 may determine the output risk value by matching behavior (e.g., data values corresponding to the input features, etc.) associated with the incoming transaction requests with one or more of the learned behavior patterns. When the transaction behavior patterns are stable, the risk model 212 can perform the risk predictions with higher accuracy. However, as discussed herein, it is common for transaction behavior to shift, sometimes over a duration (e.g., a few days, a few weeks, a few months), and sometimes indefinitely. An example that may cause a temporary sudden shift of transaction behavior may be a seasonal event (e.g., the World Cup that occurs every four years). The seasonal event may cause the monetary amounts of ticket sales with a particular vendor to rise dramatically (e.g., relative to the norm based on the training data) for a period of time (e.g., during the few months leading up to the event). Another example that may cause a permanent shift of transaction behavior may be a new established geographical region (e.g., a new shopping center). The newly established regions may cause a sudden increase of transactions conducted at that geographical region. The sudden shift of behavior may cause the risk model to incorrectly classify legitimate transactions as fraudulent transactions based on the deviation of the behavior from the norm.

Conventionally, the risk model may be re-configured and/or re-trained to adopt or adapt to the sudden shift of transaction behavior. For example, the human operator may analyze data periodically and update the rule-based model. However, it takes a substantial amount of human resources or computing resources to continuously monitor and update the rule-based model. In the case where the risk model 212 is a machine learning model, the risk model 212 can be re-trained based on more recent transaction data. However, it takes a substantial amount of time to obtain sufficient amount of training data (e.g., it takes several months to accurately label each transaction request being legitimate or fraudulent for use as training data) for re-training the machine learning model. By the time the machine learning model is re-trained, many transactions have already been mis-classified. Worse yet, the behavior pattern of legitimate transactions may have shifted back to normal (e.g., World Cup season is over), which may result in additional misclassifications by the re-trained machine learning model.

Thus, according to various embodiments of the disclosure, the risk determination module 132 may be configured to dynamically modify the risk model 212 based on detected shifts of input features to accommodate for any sudden shift in transaction behavior patterns. In some embodiments, the feature selection module 204 may select one or more input features from the input features used by the risk model 212 for performing risk predictions. The risk manager 202 may then establish benchmark statistics corresponding to the one or more input features based on past transactions (e.g., transactions that were conducted during the past 6 months, 12 months, etc.) The risk manager 202 may obtain values corresponding to a first input feature (e.g., the amount input feature) from the past transactions from the account database 136. The risk manager 202 may then determine benchmark statistics for the amount input feature based on the obtained values, such as from periods with similar conditions. The risk manager 202 may determine distribution statistics for the amount input feature based on the obtained values, such as a minimum amount, a maximum amount, a standard deviation, a skewness value, a kurtosis value, a cardinality value (e.g., a number of different amounts).

The risk manager 202 may also obtain values corresponding to a second input feature (e.g., the address input feature) from the past transactions from the account database 136. The risk manager 202 may then determine benchmark statistics for the address input feature based on the obtained values. The risk manager 202 may determine distribution statistics for the address input feature based on the obtained values, such as a standard deviation, a skewness value, a kurtosis value, a cardinality value (e.g., a number of different regions, such as cities, states, countries, etc.), and a percentage of null values in one of the address fields.

The anomaly detection module 208 may then periodically analyze values corresponding to the one or more input features from incoming transaction requests received over a period of time (e.g., the past 6 hours, 12 hours, 24 hours, etc.) to determine whether a shift in transaction behavior has occurred. For example, the anomaly detection module 208 may analyze values corresponding to the one or more input features from incoming transaction requests received over the past hour, the past 6 hours, the past 24 hours, etc. In some embodiments, the anomaly detection module 208 may determine distribution statistics of the values corresponding to the first input feature (e.g., the amount input feature) from the one or more features. For example, the anomaly detection module 208 may determine distribution statistics such as a minimum amount, a maximum amount, a standard deviation, a skewness value, a kurtosis value, a cardinality value (e.g., a number of different amounts) for the amount input feature. The anomaly detection module 208 may also determine distribution statistics such as a standard deviation, a skewness value, a kurtosis value, a cardinality value (e.g., a number of different regions, such as cities, states, countries, etc.), and a percentage of null values in one of the address fields for the address input feature.

The anomaly detection module 208 may compare the distribution statistics associated with each of the one or more features against benchmark statistics (e.g., the norm) associated with the corresponding feature. If the distribution statistics associated with a feature match the benchmark statistics associated with the corresponding feature (e.g., having a deviation associated with any one or more of the distribution statistics below a threshold or a metric), the anomaly detection module 208 may determine that no shift in the transaction behavior pattern has occurred. Thus, the risk manager 202 may determine not to modify the risk model and may continue to use the risk model to perform risk predictions for subsequent incoming transaction requests. To determine whether the distribution statistics deviate from the benchmark statistics, the anomaly detection module 208 of some embodiments may compare each individual benchmark statistic (e.g., a mean value, a minimum value, a standard deviation value, etc.) against a corresponding benchmark statistic. The anomaly detection module 208 may determine a set of rules and/or metrics to determine whether the distribution statistics match the benchmark statistics and whether the distribution statistics deviate from the benchmark statistics by a threshold. For example, the set of rules may specify that the distribution statistics deviates from the benchmark statistics by a threshold when a difference between a first distribution statistic (e.g., a mean value) and the corresponding benchmark statistic is above a first metric, a difference between a second distribution statistic (e.g., a minimum value) and the corresponding benchmark statistic is above a second metric, and so forth. The set of rules may further specify that the distribution statistics match the benchmark statistics when a difference between a first distribution statistic (e.g., a mean value) and the corresponding benchmark statistic is below a third metric, a difference between a second distribution statistic (e.g., a minimum value) and the corresponding benchmark statistic is below a fourth metric, and so forth.

However, if the distribution statistics associated with the feature deviate from the benchmark statistics associated with the corresponding feature by more than the threshold, the anomaly detection module 208 may determine that a shift in transaction behavior (e.g., legitimate transaction behavior) has likely occurred. The risk manager 202 may then use the model modification module 210 to modify the risk model 212 to accommodate the shift in transaction behavior.

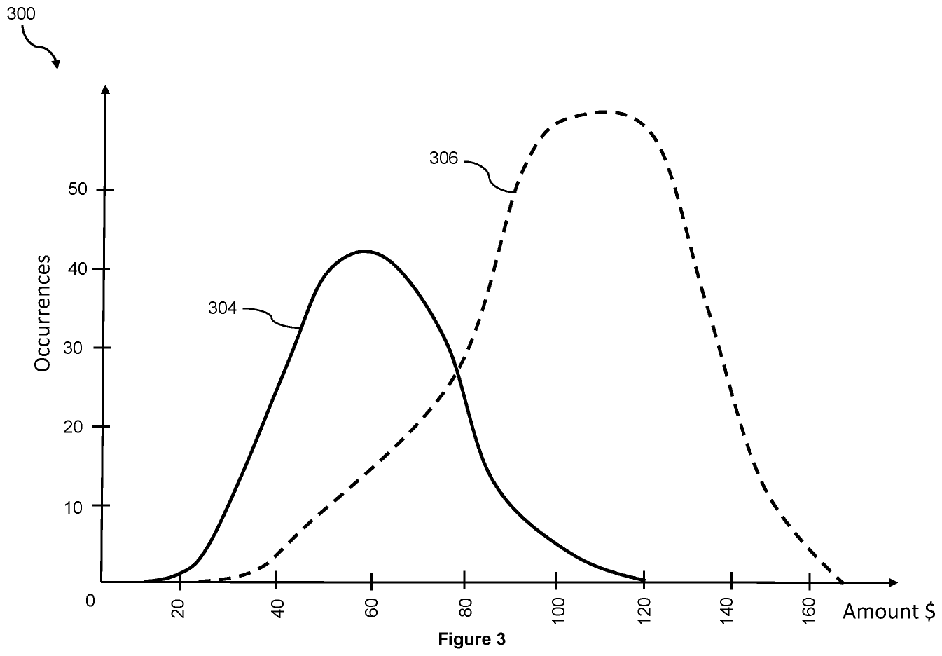

FIG. 3 illustrates a graph 300 that shows a distribution 304 based on the benchmark statistics corresponding to the amount input feature and a distribution 306 based on the distribution statistics corresponding to the amount input feature. The graph 300 has a horizontal axis that corresponds to different amounts and a vertical axis that corresponds to occurrences for different amounts. The distributions 304 and 306 of the statistics (e.g., benchmark statistics and distribution statistics) in the graph 300 show substantial deviations between the distribution statistics and the benchmark statistics. For example, the distribution 304 shows a peak (e.g., the amount that corresponds to the most occurrences) at approximately $60, while the distribution 306 shows a peak at approximately $120. The distribution 306 further shows that the amounts in the recent transactions are generally much higher than the amounts in normal transactions. In some embodiments, the anomaly detection module 208 may determine that the deviation between the distribution statistics and the benchmark statistics corresponding to the amount input feature exceeds a predetermined threshold.

In some embodiments, the anomaly detection module 208 may analyze the benchmark statistics and the distribution statistics corresponding to the address input feature in a similar manner, and may determine that a deviation between the distribution statistics and the benchmark statistics corresponding to the address input feature exceeds the predetermined threshold. For example, the anomaly detection module 208 may determine that a substantially larger number of recent transactions are associated with one or more particular regions based on the billing addresses and/or the shipping addresses of the transactions.

In some embodiments, once the anomaly detection module 208 detects the anomaly in the input values of the recent transactions (e.g., the deviations between the input values of the recent transactions and the benchmarks exceed the threshold), the risk manager 202 may transmit an alert to a device (e.g., the user device 180 that is associated with the service provider server 130) indicating the anomaly. The user device 180 may be associated with a person working for the online service provider. Upon receiving the indication, the person may perform additional investigation regarding the shift of behavior pattern. The person may then indicate to the risk determination module 132 via the user device 180 that the shift of behavior is normal based on the investigation.

In some embodiments, the risk manager 202 may perform an automatic investigation when the shift of behavior pattern is detected. For example, the risk determination module 132 may include a web crawler to obtain news from various websites on the Internet. The risk determination module 132 may analyze news report to determine whether a correlation exists between a news report and the pattern shift. In some embodiments, the risk determination module 132 may perform linguistic analysis on the news report to detect whether words and phrases within the news report correlate the particular input feature. Using the above example where an increase in transaction amounts in transactions with the particular vendor has occurred, the risk determination module 132 may determine whether any news report includes words or phrases related to the name of the particular vendor, a category of the particular vendor, and/or products associated with the particular vendor (e.g., sports event tickets, etc.). In some embodiments, the risk determination module 132 may modify the risk model to accommodate the shift in transaction pattern only after the shift in transaction pattern has been verified (e.g., determining a correlation between the shift in transaction pattern and a news report, etc.).

Thus, the risk manager 202 may use the model modification module 210 to modify the risk model 212 based on the deviation(s). For example, the model modification module 210 may adjust one or more parameters within the risk model 212 in determining a risk of a transaction request (or classify the transaction request as legitimate or fraudulent). In some embodiments, the risk model 212 may be configured and/or trained to recognize that a transaction from a particular vendor having a transaction amount over a threshold amount is considered high risk based on training data the indicates that a large portion of past transactions with this particular vendor are associated with amounts below the threshold (e.g., based on the benchmark statistics). When the anomaly detection module 208 detects the shift of behavior pattern where the recent transactions (e.g., transaction conducted from the past 6 hours, 12 hours, 24 hours, etc.) has substantially larger portions of transactions with transaction amounts over the threshold amount, the model modification module 210 may modify the risk model 212 by adjusting the amount threshold parameter (e.g., by increasing the amount threshold parameter).

In some embodiments, the risk model 212 may also be configured and/or trained to recognize that a transaction from a particular vendor having an address (e.g., a billing address, a shipping address, etc.) associated with the one or more particular regions is considered high risk based on training data that indicates that very few (or none of the) past transactions with this particular vendor are associated with the one or more particular regions (e.g., based on the benchmark statistics). When the anomaly detection module 208 detects the shift of behavior pattern where the recent transactions (e.g., transaction conducted from the past 6 hours, 12 hours, 24 hours, etc.) has substantially larger portions of transactions associated with the one or more particular regions, the model modification module 210 may modify the risk model 212 by adjusting the address threshold parameter (e.g., by taking the one or more particular regions from a blacklist, etc.).

After modifying the risk model 212, the risk analysis module 206 may begin using the modified risk model 212 (instead of the original risk model 212) to perform risk predictions for incoming transaction requests. For example, using the modified risk model 212, the risk analysis module 206 may determine that a transaction request having a transaction amount above the amount threshold would be acceptable (e.g., low risk), and thus, would authorize the transaction request, whereas using the original risk model 212, the risk analysis module 206 may determine that the transaction request is of high risk and may deny the request.

Since the sudden shift in transaction behavior may be a temporary shift (e.g., until the end of the sports event), it may not be desirable to use the modified risk model 212 permanently. Thus, in some embodiments, the risk manager 202 may determine an expiration time (e.g., 1 day, 3 days, etc.) to the modification to the risk model 212. In some embodiments, the risk determination system of some embodiments may assign an initial expiration time (e.g., a first expiration time, such as a day, 2 days from the modification) for the modification to the risk model. At the expiration time, the risk determination system may revert the modified risk model 212 back to the original risk model 212 before the modification (e.g., reverting the adjusted parameters back to the original parameters prior to the modification).

In some embodiments, after modifying the risk model 212 by the model modification module 210, the risk manager 202 may continue to monitor values associated with incoming transaction requests that correspond to the one or more input features (e.g., amount input feature, address input feature, etc.). For example, the risk manager 202 may obtain values corresponding to the one or more feature and associated with transaction requests after the risk model 212 is modified. The risk manager 202 may also determine distribution statistics based on the values associated with the incoming transaction requests. The anomaly detection module 208 may compare the distribution statistics against the benchmark statistics (e.g., the norm) and/or the previously determined distribution statistics. In some embodiments, based on the comparison and the amount of time elapsed since the shift of the transaction pattern, the risk manager 202 may adjust the expiration time associated with the modification to the risk model 212.

For example, if the comparison shows that the shift of the transaction behavior remains (e.g., the distribution statistics of the recent transactions still deviate from the benchmark statistics more than the threshold), the risk manager 202 may extend the expiration time for the modification to the risk model 212. In some embodiments, the risk manager 202 may extend the expiration time based on the amount of time elapsed since the shift of the transaction pattern. The longer the transaction pattern has been shifted, the longer the risk manager 202 may extend the expiration time. For example, the risk manager 202 may extend the expiration time by the amount of time elapsed since the shift of the transaction pattern (or a number of time in proportion to the amount of time elapsed). Thus, if the shift of the transaction pattern has lasted for a day, the risk manager 202 may extend the expiration time by a day. In some embodiments, when it is determined that the shift of transaction pattern has lasted longer than a threshold period of time (e.g., several weeks, several months, etc.), the risk manager 202 may remove the expiration time such that the modification to the risk model is permanent until events or data indicate that the risk model needs to be modified again, either temporarily or permanently.

In some embodiments, if the comparison shows that the shift of the transaction behavior has been reduced (e.g., the deviation from the benchmark statistics is smaller than the previous deviation) and/or has ended (e.g., the deviation is less than the threshold), the risk manager 202 may reduce the expiration time. For example, the risk manager 202 may reduce (or shorten) the expiration time of the modification to the risk model 212 based on a difference between the deviation associated with the current distribution statistics and the previous deviation associated with the previous distribution statistics. Thus, the risk manager 202 may reduce (or shorten) the expiration time by a greater extent when the difference is greater and by a smaller extent when the difference is smaller.

In some embodiments, the risk manager 202 may continue to monitor the values corresponding to the one or more input features and other input features associated with incoming transaction requests to determine whether the shift of the transaction pattern continues and whether a different shift of the transaction pattern is detected. The risk determination module 132 may continue to modify the risk model 212 using the techniques described herein based on the shift of the transaction pattern detected using values of input features. By dynamically modifying the risk model 212 based on stability of input values corresponding to input features (instead of changes in the labeling of transaction requests corresponding to the output values of the risk model 212), the risk model 212 can be quickly modified to reflect the current transaction behavior pattern, which can substantially improve accuracy of fraudulent transaction request detection and network security.

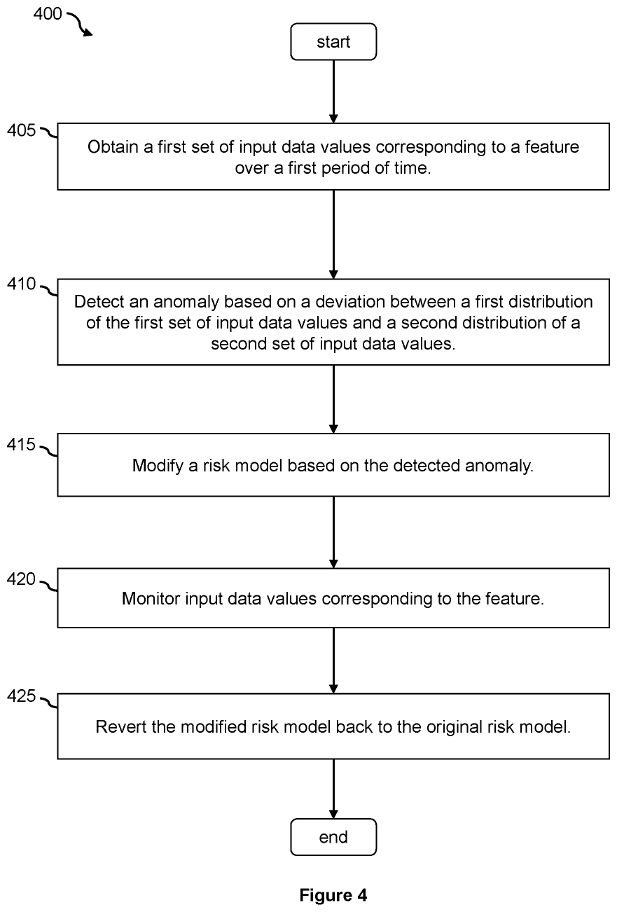

FIG. 4 illustrates a process 400 of dynamically modifying a risk model based on a shift of input features according to various embodiments of the disclosure. In some embodiments, at least some of all of the steps in the process 400 may be performed by the risk determination module 132. The process 400 begins by obtaining (at step 405) a first set of input data values corresponding to a feature over a first period of time (e.g., the past 6 hours, 12 hours, 24 hours, etc.). For example, the feature selection module 204 may select one or more input features for examining. The risk manager 202 may then obtain input values corresponding to the input features (e.g., amount input feature, address input feature, etc.) from the account database 136 and/or the service application 138.

The process 400 then detects (at step 410) an anomaly based on a deviation between a first distribution of the first set of input data values and a second distribution of a second input data values. For example, the anomaly detection module 208 may determine benchmark statistics for the selected input feature (e.g., amount input feature) based on input data values associated with transaction requests received by the online service provider over a second period of time (e.g., the past 6 months, the past year, etc.). In some embodiments, the second period of time is prior to the first period of time and/or longer than the first period of time. The benchmark statistics may correspond to the distribution 304 in FIG. 3. In some embodiments, the anomaly detection module 208 may determine distribution statistics based on the obtained input data values corresponding to the feature, which may correspond to the distribution 306 in FIG. 3. The anomaly detection module 208 may determine that an anomaly exists when a deviation between the benchmark statistics (e.g., the distribution 304) and the distribution statistics (e.g., the distribution 306) exceeds a threshold, which can vary based on volume of activity, dollar amounts, country, etc.

The process 400 then modifies (at step 415) a risk model based on the detected anomaly. For example, the model modification module 210 may modify the risk model 212 based on the deviation by adjusting one or more parameters (e.g., threshold values) corresponding to the input feature(s). The risk analysis module 206 may then perform risk predictions for incoming transaction requests (e.g., from the user device 110, the merchant server 120, etc.) using the modified risk model 212, such that the transaction requests exhibiting behavior associated with the sudden shift of behavior pattern would be authorized.

The process 400 then monitors (at step 420) input data values corresponding to the features. Since the sudden shift of transaction behavior may be temporary, the risk manager 202 may determine an expiration time for the modification to the risk model 212. When the expiration time has arrived, the risk manager 202 may use the model modification module 210 to revert the modified risk model 212 back to the original risk model. The risk manager 202 may continue to monitor the input values corresponding to the input features associated with incoming transaction requests. For example, the anomaly detection module 208 may determine if the sudden shift of transaction behavior is sustaining or is receding. If the shift of transaction behavior is sustaining, the risk manager 202 may extend the expiration time. By contrast, if the shift of transaction is receding, the risk manager 202 may shorten the expiration time.

The process 400 then reverts (at step 425) the modified risk model back to the original risk model. For example, when it is determined that the modification has expired based on the expiration time, the model modification module 210 may revert the modified risk model 212 back to the pre-modified state (e.g., reverting the adjusted one or more parameters).

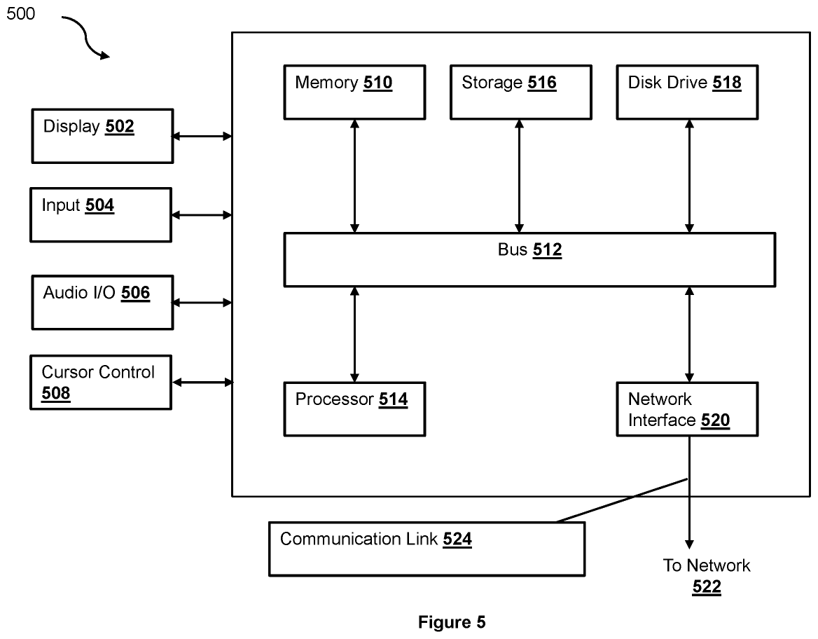

FIG. 5 is a block diagram of a computer system 500 suitable for implementing one or more embodiments of the present disclosure, including the service provider server 130, the merchant server 120, and the user devices 110 and 180. In various implementations, each of the user devices 110 and 180 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices 110, 120, 130, and 180 may be implemented as the computer system 500 in a manner as follows.

The computer system 500 includes a bus 512 or other communication mechanism for communicating information data, signals, and information between various components of the computer system 500. The components include an input/output (I/O) component 504 that processes a user (i.e., sender, recipient, service provider) action, such as selecting keys from a keypad/keyboard, selecting one or more buttons or links, etc., and sends a corresponding signal to the bus 512. The I/O component 504 may also include an output component, such as a display 502 and a cursor control 508 (such as a keyboard, keypad, mouse, etc.). The display 502 may be configured to present a login page for logging into a user account or a checkout page for purchasing an item from a merchant. An optional audio input/output component 506 may also be included to allow a user to use voice for inputting information by converting audio signals. The audio I/O component 506 may allow the user to hear audio. A transceiver or network interface 520 transmits and receives signals between the computer system 500 and other devices, such as another user device, a merchant server, or a service provider server via network 522. In one embodiment, the transmission is wireless, although other transmission mediums and methods may also be suitable. A processor 514, which can be a micro-controller, digital signal processor (DSP), or other processing component, processes these various signals, such as for display on the computer system 500 or transmission to other devices via a communication link 524. The processor 514 may also control transmission of information, such as cookies or IP addresses, to other devices.

The components of the computer system 500 also include a system memory component 510 (e.g., RAM), a static storage component 516 (e.g., ROM), and/or a disk drive 518 (e.g., a solid-state drive, a hard drive). The computer system 500 performs specific operations by the processor 514 and other components by executing one or more sequences of instructions contained in the system memory component 510. For example, the processor 514 can perform the risk model modification functionalities described herein according to the process 300.

Logic may be encoded in a computer readable medium, which may refer to any medium that participates in providing instructions to the processor 514 for execution. Such a medium may take many forms, including but not limited to, non-volatile media, volatile media, and transmission media. In various implementations, non-volatile media includes optical or magnetic disks, volatile media includes dynamic memory, such as the system memory component 510, and transmission media includes coaxial cables, copper wire, and fiber optics, including wires that comprise the bus 512. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 500. In various other embodiments of the present disclosure, a plurality of computer systems 500 coupled by the communication link 524 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a non-transitory memory; and
one or more hardware processors coupled with the non-transitory memory and configured to read instructions from the non-transitory memory to cause the system to perform operations comprising:
providing a first set of input data values corresponding to a feature to a machine learning model over a first period of time, wherein the machine learning model is configured to perform first risk predictions for a first set of transactions based on the first set of input data;
detecting an anomaly based on a deviation between a first distribution characteristic associated with the first set of input data values and a second distribution characteristic associated with a second set of input data values corresponding to the feature and associated with a second set of transactions; and
in response to detecting the anomaly, modifying the machine learning model by adjusting one or more parameter thresholds of the machine learning model.

2. The system of claim 1, wherein the operations further comprise selecting, from a plurality of parameter thresholds associated with the machine learning model, the one or more parameter thresholds based on the feature.

3. The system of claim 1, wherein the operations further comprise:
determining that a particular amount of time has passed since the modifying the machine learning model; and
in response to determining that the predetermined amount of time has passed, reverting the modified machine learning model back to the machine learning model.

4. The system of claim 3, wherein the particular amount of time is determined based on the deviation.

5. The system of claim 3, wherein the operations further comprise:
providing a third set of input data values corresponding the feature to the machine learning model over a third period of time for performing third risk predictions for a third set of transactions, wherein the third period of time is subsequent to the first period of time;
determining that the anomaly remains in existence based on a second deviation between a third distribution characteristic associated with the third set of input data values and the second distribution; and
in response to determining that the anomaly remains, increasing the particular amount of time.

6. The system of claim 1, wherein the first distribution comprises at least one of a mean value, a standard deviation, or a skewness value.

7. The system of claim 1, wherein the operations further comprise:
receiving a transaction request;
obtaining, from the transaction request, input values for the modified machine learning model;
generating, using the modified machine learning model, a risk value for the transaction request based on the input values; and
processing the transaction request based on the risk value.

8. A method, comprising:
obtaining, by one or more hardware processors, a first set of input data values corresponding to an input feature and associated with a first set of transactions, wherein the input feature is an input feature among a plurality of input features associated with a risk model for performing risk predictions for incoming transaction requests;
comparing, by the one or more hardware processors, a first distribution associated with the first set of input data values against a benchmark distribution;
detecting, by the one or more hardware processors, an anomaly based on a difference between the first distribution and the benchmark distribution; and
in response to detecting the anomaly, modifying, by the one or more hardware processors, the risk model for performing risk predictions on incoming transaction requests by adjusting one or more parameter thresholds of the risk model.

9. The method of claim 8, further comprising:
receiving a transaction request;
extracting data values corresponding to the plurality of input features from the transaction request; and
determining a risk value for the transaction request based on the modified risk model.

10. The method of claim 8, further comprising:
determining that an event related to the anomaly occurred within a time threshold prior to the first period of time, wherein the risk model is modified based on the determining that the event related to the anomaly occurred within the time threshold.

11. The method of claim 8, wherein the first set of input data values are submitted to the risk model for performing risk predictions for the first set of transactions.

12. The method of claim 8, wherein the feature is a monetary amount or an address field.

13. The method of claim 8, wherein the first distribution comprises at least one of a kurtosis value, a cardinality, or a percentage of null values.

14. The method of claim 8, further comprising:
determining that a particular amount of time has passed since the modifying the risk model; and
in response to determining that the predetermined amount of time has passed, reverting the modified risk model back to the risk model.

15. A non-transitory machine-readable medium having stored thereon machine-readable instructions executable to cause a machine to perform operations comprising:
obtaining a first set of input data values corresponding to an input feature and associated with a first set of transactions, wherein the input feature is selected among a plurality of input features associated with a risk model for performing risk predictions for incoming transaction requests;
determining a first distribution based on the first set of input data values;
detecting an anomaly based on a difference between the first distribution and a benchmark distribution;
in response to detecting the anomaly, modifying the risk model for performing risk predictions for subsequent incoming transaction requests by adjusting one or more parameter thresholds of the risk model;
receiving a transaction request;
obtaining, from the transaction request, input values corresponding to the plurality of input features;
determining, using the modified risk model, a risk value associated with the transaction request; and
processing the transaction request based on the risk value.

16. The non-transitory machine-readable medium of claim 15, wherein the operations further comprise:
determining that a particular amount of time has passed since the modifying the risk model; and
in response to determining that the predetermined amount of time has passed, reverting the modified risk model back to the risk model.

17. The non-transitory machine-readable medium of claim 16, wherein the particular amount of time is determined based on the deviation.

18. The non-transitory machine-readable medium of claim 16, wherein the operations further comprise:
obtaining a second set of input data values corresponding the input feature and associated with a first set of transactions;
determining a second distribution based on the second set of input data values;
determining that the anomaly has receded in existence based on a second difference between the second distribution and the benchmark distribution; and
in response to determining that the anomaly has receded, decreasing the particular amount of time.

19. The non-transitory machine-readable medium of claim 15, wherein the operations further comprise:
determining that an event related to the anomaly occurred within a time threshold prior to the first period of time, wherein the risk model is modified based on the determining that the event related to the anomaly occurred within the time threshold.

20. The non-transitory machine-readable medium of claim 19, wherein the operations further comprise:
detecting that the event related to the anomaly has ended based on online information related to the event;
in response to detecting that the event has ended, reverting the modified risk model back to the risk model.
